(19) United States
(12) Patent Application Publication
(10) Pub. No.: US 2010/0246050 A1
(43) Pub. Date: Sep. 30, 2010

(54) STORAGE DEVICE

(75) Inventor: Hideki YAMAGUCHI, Sagamihara-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/751,818

(22) Filed: Mar. 31, 2010

(30) Foreign Application Priority Data
Mar. 31, 2009 (JP) 2009-087731

(51) Int. Cl. G11B 15/18

(52) U.S. Cl. 360/71; G9B/15.021

(57) ABSTRACT

According to one embodiment, a storage device includes a base, a drive section on the base, configured to rotate a disk storage medium, an actuator mounted with a head for processing data in the storage medium and configured to move the head along a surface of the storage medium, a cover laid over the base, and a plate opposed to the surface of the storage medium in a position outside a range of movement of the actuator. The plate includes a distal end portion located adjacent to the actuator and downstream with respect to a direction of rotation of the storage medium, a block extending from the distal end portion, located outside the outer periphery of the storage medium, and supported on the base side, and an elastically deformable plate arm extending from the block toward the cover and configured to abut an inner surface of the cover.

### CROSS-REFERENCE TO RELATED APPLICATIONS

This application is based upon and claims the benefit of priority from Japanese Patent Application No. 2009-087731, filed Mar. 31, 2009, the entire contents of which are incorporated herein by reference.

### BACKGROUND

1. Field

One embodiment of the invention relates to a storage device, such as a magnetic disk drive, and a plate incorporated in the storage device.

2. Description of the Related Art

A modern magnetic disk drive with an increased storage capacity is generally configured so that a plurality of magnetic disk media are arranged as a spaced array and integrally rotated. With an increase in access speed attributable to the increased storage capacity of the disk drive, the rotational speed of a spindle motor for rotating the disk media has been increasing.

If the magnetic disk media rotate at high speed, airflow that is produced by the rotation also becomes faster, so that wind disturbance to the actuator is increased by a resulting turbulence of the airflow. This wind disturbance induces unwanted vibration of actuator arms that hold magnetic heads, so that the positioning accuracy of the heads is inevitably reduced.

To solve this problem, plate-shaped members or “plates” may be arranged individually in gaps between the adjacent magnetic disk media, in some cases. These plates serve to reduce the flow rate of the airflow produced by the rotation of the disk media and enable the magnetic heads smoothly to access the disk media.

The magnetic disk media are accessed by the magnetic heads that are mounted on the respective distal end portions of the actuator arms. Therefore, the plates are located so as not to overlap a range of movement of the arms. Preferably, however, the plates should spread as close to the actuator arms as possible, on the downstream side of the disk media (or on the upstream side of the actuator) with respect to the direction of rotation. The plates are fixed to a base or the like of the magnetic disk drive by, for example, screws. Since the screws or other fixing components hinder the movement of the actuator arms in positions near the arms, however, they are fixed in positions distant from the arms. Thus, those parts of the plates which are located near the actuator arms are cantilevered and brought to some unstable motion, such as vertical vibration, by the airflow. Consequently, the airflow may be disturbed and hinder reliable access by the magnetic heads.

A proposal is made that the vibration of the plates be suppressed by pressing both the base and a cover of the magnetic disk drive to prop the plates, in the most downstream position on the plates with respect to the direction of rotation of the magnetic disk media.

If the plates are propped in this manner, however, clearances may be formed between the cover and plates because of component tolerances or the like so that the support is insufficient. If the prop size is determined so as to provide constant and reliable support, however, the cover is then thrust up from below, possibly causing deformation of or defective closure by the cover.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a magnetic disk drive according to one embodiment of the invention;

FIG. 2 is an exemplary plan view of the magnetic disk drive according to the embodiment;

FIG. 3 is an exemplary sectional view of the magnetic disk drive taken along line E-E of FIG. 2;

FIG. 4 is an exemplary perspective view showing respective distal end portions of plates of the magnetic disk drive according to the present embodiment;

FIG. 5 is an exemplary perspective view showing how only the plates are mounted on a base of the magnetic disk drive;

FIG. 6A is an exemplary perspective view of one of the plate;

FIG. 6B is an exemplary enlarged perspective view showing a part of the plate of FIG. 6A;

FIG. 7A is an exemplary perspective view of the plate taken from another direction; and

FIG. 7B is an exemplary enlarged perspective view showing a part of the plate of FIG. 7A.

### DETAILED DESCRIPTION

Various embodiments according to the invention will be described hereinafter with reference to the accompanying drawings. In general, according to an aspect of the invention, there is provided a storage device comprising: a base; a drive section on the base, configured to rotate a disk storage medium; an actuator mounted with a head for processing data in the storage medium and configured to move the head along a surface of the storage medium; a cover laid over the base; and a plate opposed to the surface of the storage medium in a position outside a range of movement of the actuator, the plate comprising a distal end portion located adjacent to the actuator and downstream with respect to a direction of rotation of the storage medium, a block extending from the distal end portion, located outside the outer periphery of the storage medium, and supported on the base side, and an elastically deformable plate arm extending from the block toward the cover and configured to abut an inner surface of the cover.

Embodiments of the present invention will now be described in detail with reference to the accompanying drawings.

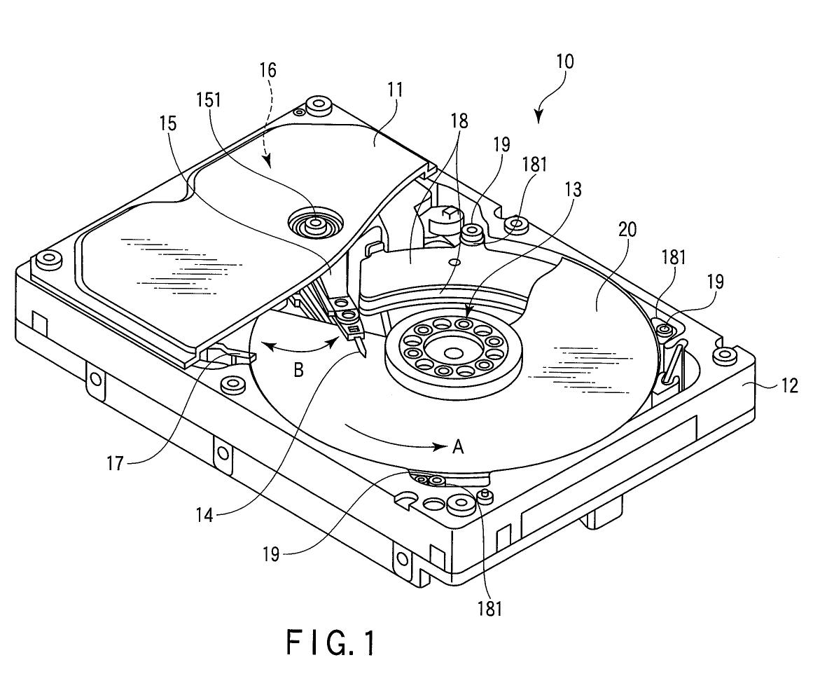

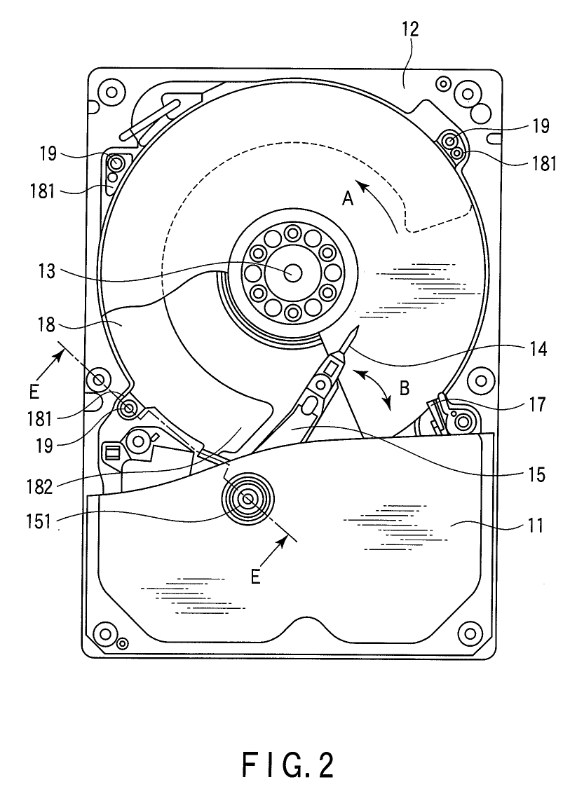

FIG. 1 is a perspective view showing a magnetic disk drive 10 according to an embodiment, and FIG. 2 is a plan view of the magnetic disk drive. In FIGS. 1 and 2, the internal structure of the magnetic disk drive 10 is exposed in such a manner that a housing cover 11 and magnetic disk medium 20 are partially cut away. The disk medium 20, which is disk-shape, is an example of a storage medium.

As shown in FIGS. 1 and 2, the magnetic disk drive 10 is provided with a flat rectangular housing, which comprises an open-topped base 12 and the cover 11 that closes the top opening of the base. The housing cover 11, which is cut away and only partially shown in FIGS. 1 and 2, is a plate member configured to cover all contents in the base 12. A plurality of magnetic disk media 20 are contained in the housing. The base 12 carries thereon a spindle motor 13 for use as a drive section, which supports and rotates the magnetic disk media 20 in the direction of arrow A. In the present embodiment, as shown in FIGS. 1 to 4, the disk media 20 (three in number) are arranged as a spaced array. The spindle motor 13 integrally rotates the three disk media 20.

The magnetic disk drive 10 comprises actuator arms 15, each carrying magnetic heads 14 on their distal end side, and a voice coil motor 16. The motor 16 pivots the actuator arms 15 in the direction of arrow B around a pivot shaft 151. If the actuator arms 15 pivot in the direction of arrow B, the heads 14 on the distal end side of the arms 15 move along the surfaces of the magnetic disk media 20 between loading and unloading positions. In the loading position, the heads 14 face the disk medium surfaces. The unloading position is outwardly separated from the respective outer peripheries of the disk media 20. A ramp 17 that supports the respective distal ends of the actuator arms 15 moved to the unloading position is fixed in the unloading position. The actuator arms 15, which are as many as the magnetic disk media 20, are arranged as an array, and the heads 14 are six in total, one corresponding to each of the obverse and reverse surfaces of each disk medium 20. The ramp 17 is configured to support the respective distal ends of the arrayed actuator arms 15.

The magnetic disk drive 10 comprises plates 18 that are located between the adjacent magnetic disk media 20 so as not to hinder the pivoting of the actuator arms 15. Each plate 18 is an arcuate plate member formed of a part of a circular arc when viewed vertically from above. In the present embodiment, the three disk media 20 are arranged as a spaced array. Therefore, the plates 18 are two in total, one between the lowermost and central disk media and other between the central and uppermost disk media.

The plates 18 are located coaxially with the magnetic disk media 20 and parallel to the surfaces of the disk media in a spaced manner. The respective outer peripheral edges of the plates 18 are substantially aligned with those of the disk media 20.

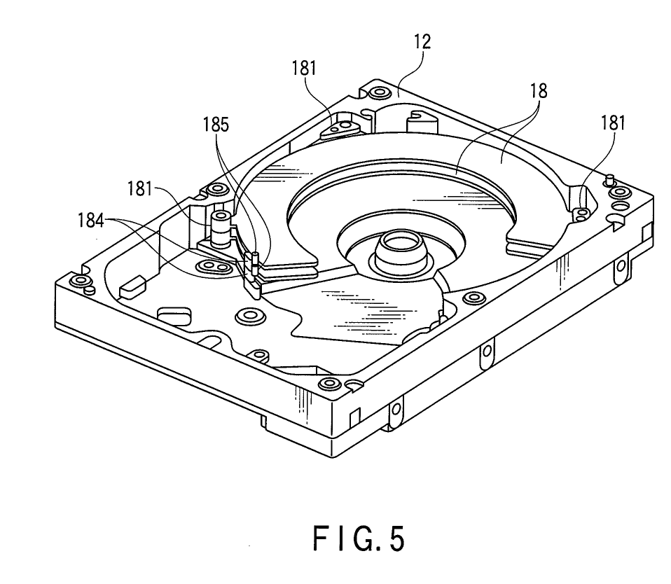

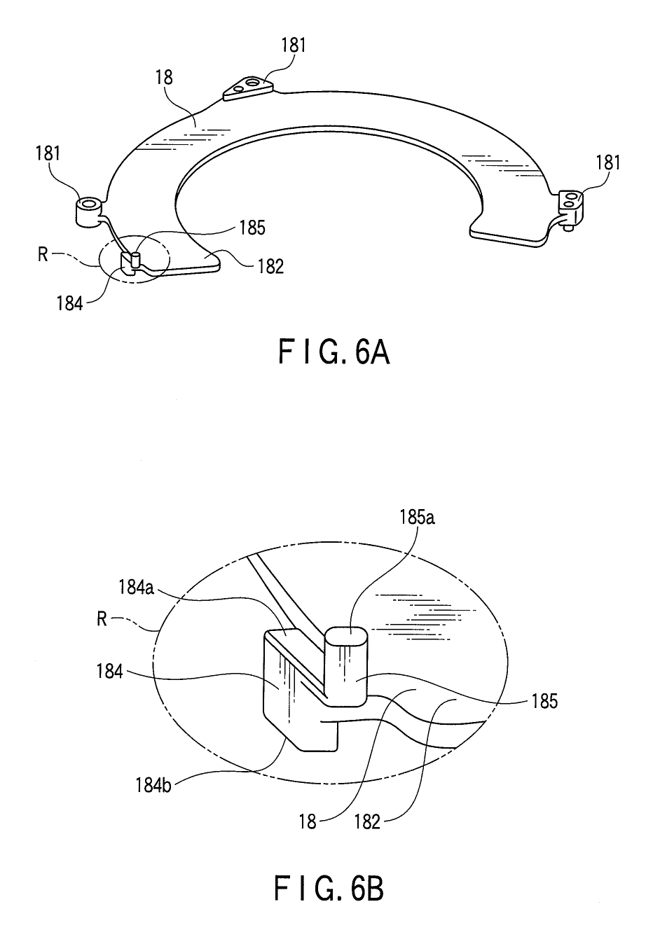

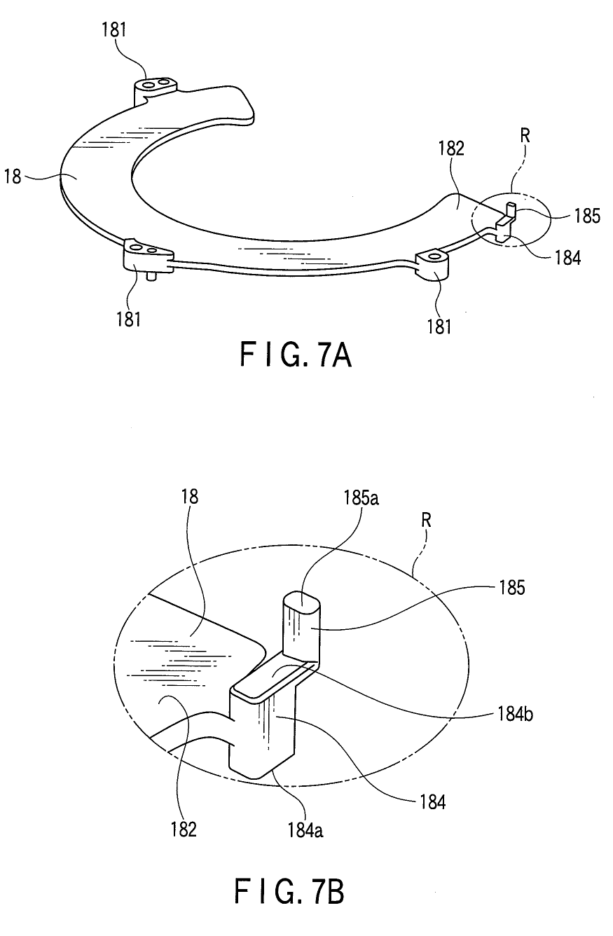

As shown in FIGS. 1 to 5, 6A, 6B, 7A and 7B, each plate 18 comprises fixing portions 181 in a plurality of (e.g., three) areas along the peripheral edge of its corresponding magnetic disk medium 20. Each fixing portion 181 projects outwardly beyond the outer periphery of each disk medium 20 from the outer peripheral edge of each plate 18. The fixing portions 181 of the two plates 18, upper and lower, are mounted in layers on the base 12 and fixed to the base 12 by screws 19.

A distal end portion 182 of each plate 18 that is located downstream with respect to the direction of rotation A of each magnetic disk medium 20, that is, the distal end portion on the side of each actuator arm 15, extends close to the arm 15 without the possibility of hindering the action of the arm.

The distal end portion 182 of each plate 18 is provided integrally with a block 184, which projects outwardly beyond the outer periphery of each magnetic disk medium 20 from the outer peripheral edge of each plate 18. The block 184 has an upper surface 184a and lower surface 184b that are parallel to the surface of the disk medium 20. A plate arm 185 protrudes from the block 184. After extending parallel to the disk medium surface from the block 184, the arm 185 further extends at right angles to the medium surface or toward the cover 11 in this case. The arm 185 is elastically deformable and is located outside the outer peripheral edge of the disk medium 20.

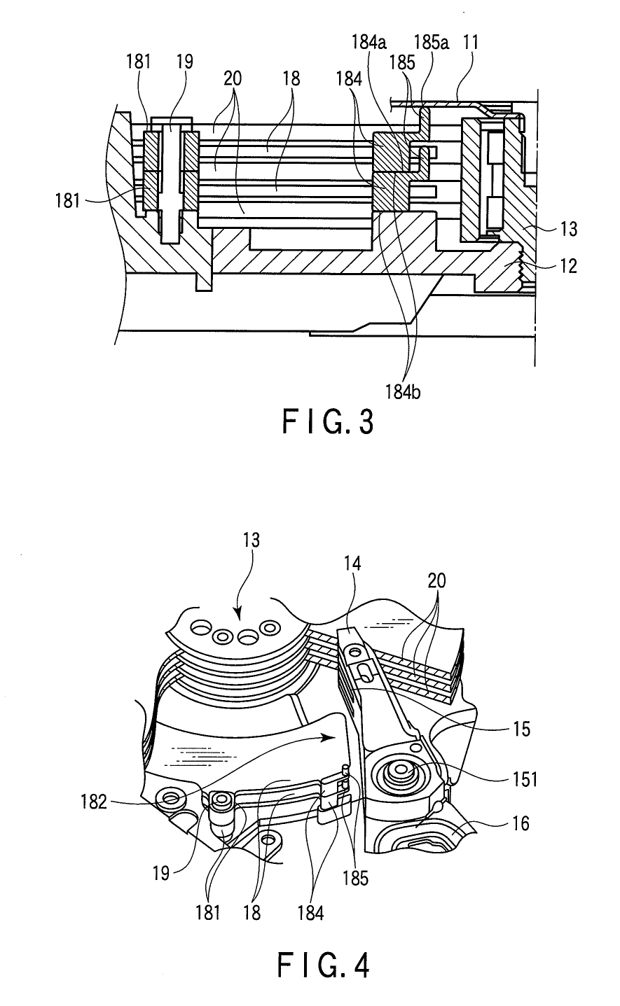

When the plates 18 are mounted on the base 12, as clearly seen from FIGS. 3 and 4, each block 184 is located so that its lower surface 184b lies on the base 12 or on the upper surface 184a of the block 184 of the lower plate 18. A distal end 185a of the plate arm 185 of the uppermost plate 18 (or second-stage plate 18 in this case) that is located closest to the cover 11 abuts the inner surface of the cover. The plate arm 185 is of such a size that it can securely abut the inner surface of the cover 11 despite variation in workmanship. The arm 185 is configured to be elastically bent when it is pushed by the cover 11.

Only the plate arm 185 of the uppermost plate 18 abuts the cover 11. Since the plate arm 185 is also formed for each of the other plates 18, however, a common die set can be used for the manufacture of the plurality of plates 18.

Since the block 184 does not need to be provided with any threaded hole, its projection from the outer periphery of each magnetic disk medium 20 can be made smaller than in the case of the fixing portions 181 for screw attachment. Thus, the block 184 can be located without hindering the action of the actuator arms 15.

The layered blocks 184 and the uppermost plate arm 185 form a column, such as a support rod that supports the respective distal end portions 182 of the plates 18, between the base 12 and cover 11, whereby vibration of the distal end portions 182 can be suppressed. Accordingly, the distal end portion 182 of each plate 18 can be made to extend close to its corresponding actuator arm 15 without the possibility of hindering the action of the arm. Thus, the plates 18 can suppress vibration of the actuator arms 15 and the like attributable to airflow, so that the magnetic disk media 20 can be reliably accessed.

Since the plate arm 185 of the uppermost plate 18 is configured to be elastically bent when it is pushed by the cover 11, moreover, deformation of or defective closure by the cover 11 can also be suppressed.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

Although the magnetic disk drive has been given as an example of a storage device in connection with the embodiment described herein, for example, the present invention is not limited to this embodiment. The invention is generally applicable to any storage devices in which a plurality of disk storage media arranged as a spaced array are integrally rotated.

What is claimed is:

1. A storage device comprising:
a base;
a rotator on the base, configured to rotate a disk storage medium;
an actuator with a head configured to read data from the storage medium and to write data to the storage medium, and configured to move the head along a surface of the storage medium;
a cover over the base; and
a plate facing the surface of the storage medium in a position outside an area of movement of the actuator, the plate comprising a distal end portion next to the actuator and at a downstream side with respect to a direction of rotation of the storage medium, a block extending from the distal end portion at outside the outer periphery of the storage medium, and supported on the base side, and an elastic plate arm extending from the block toward the cover and configured to touch an inner surface of the cover.

2. The storage device of claim 1, wherein the plate is an arcuate plate comprising an outer peripheral edge along an outer peripheral edge of the storage medium.

3. The storage device of claim 2, wherein the plate comprises a plurality of attaching portions extending from the outer peripheral edge thereof to the outside of the outer peripheral edge of the storage medium.

4. The storage device of claim 1, wherein the plate arm is toward the cover in parallel with the surface of the storage medium from the block.

5. The storage device of claim 1, further comprising a plurality of storage media as a spaced array and supported on the rotator and a plurality of plates, each plate between each two adjacent storage media outside the area of movement of the actuator comprising the distal end portion next to the actuator and at the downstream side with respect to the direction of rotation of the storage media, a block extending from the distal end portion at outside the respective outer peripheries of the storage media and on the base or an upper surface of the block of each plate, and an elastic plate arm extending from the block toward the cover and configured to touch an inner surface of the cover.

6. A plate in a storage device comprising a base, a rotator on the base and configured to rotate a disk storage medium, an actuator with a head configured to read information from the storage medium and to write data to the storage medium, and configured to move the head along a surface of the storage medium, and a cover over the base,
the plate facing the surface of the storage medium in a position outside an area of movement of the actuator,
the plate comprising:
a distal end portion next to the actuator and at a downstream side with respect to a direction of rotation of the storage medium,
a block extending from the distal end portion at outside the outer periphery of the storage medium, and configured to be supported on the base side, and
an elastic plate arm extending from the block toward the cover and configured to touch an inner surface of the cover.

7. The plate of claim 6, further comprising an arcuate shape and an outer peripheral edge along an outer peripheral edge of the storage medium.

8. The plate of claim 7, further comprising a plurality of attaching portions extending from the outer peripheral edge thereof to the outside of the outer peripheral edge of the storage medium.

9. The plate of claim 6, wherein the plate arm is toward the cover in parallel with the surface of the storage medium from the block.
